(19) United States
(12) Patent Application Publication
(10) Pub. No.: US 2006/0232838 A1
(43) Pub. Date: Oct. 19, 2006

(54) Method and apparatus for forming a surface-relief hologram mask

(75) Inventor: Francis Stace Murray Clube, Neuchatel (CH)

Correspondence Address: Holoptics SA, Champs-Montants 12c, Marin, CH-2074, CH

(73) Assignee: Holoptics SA

(21) Appl. No.: 11/104,204

(22) Filed: Apr. 13, 2005

(51) Int. Cl. G03H 1/20

(52) U.S. Cl. 359/12; 359/35

(57) ABSTRACT

A method for manufacturing a surface-relief hologram mask for use on a lithographic system based on TIR holography that includes providing a master hologram mask of a pattern recorded using TIR holography, arranging said master hologram mask on the first face of a coupling element having a second face through which an exposure beam from an illumination system may pass for reconstructing the pattern recorded in the master hologram mask, arranging a recording plate bearing a layer of a surface-relief holographic recording material in proximity or in contact with the master hologram mask such that light in an exposure beam that is not diffracted by the master hologram mask is transmitted into the recording layer, inhibiting the recording by an exposure beam from the illumination system of the reflection image hologram in the recording layer, and recording the transmission image hologram of the master hologram mask in the recording layer.

The present invention relates to the field of total internal reflection (TIR) holography, and in particular to TIR holography as employed for photolithography.

The prior art teaches that an important application of TIR holography is for printing high-resolution microcircuit patterns, especially on glass substrates for manufacturing certain flat panel displays (e.g. U.S. Pat. No. 4,917,497, U.S. Pat. No. 4,966,428, U.S. Pat. No. 5,640,257, U.S. Pat. No. 5,695,894 and U.S. Pat. No. 6,657,756). According to the method, a hologram mask is recorded from a conventional chrome mask bearing a pattern of features by firstly placing the mask in close proximity to a holographic recording layer on a glass plate arranged on a glass prism. The mask is then illuminated with an object laser beam whilst simultaneously illuminating the holographic recording layer with a mutually coherent reference laser beam through the prism at such an angle that the reference beam is totally internally reflected from the surface of the holographic layer. The optical interference of the light transmitted by the mask with the reference beam is recorded by the photosensitive material in the holographic recording layer, which is subsequently fixed by an appropriate processing step, to form the hologram mask. The mask pattern can afterwards be regenerated, or reconstructed, from the hologram mask by re-mounting the hologram mask on a glass prism and illuminating it through the prism with a laser beam having the same wavelength as the laser beam used for recording the hologram. The pattern may be printed by placing a substrate, such as a silicon wafer or a glass plate, coated with a layer of photoresist at the same distance from the hologram as the chrome mask was during recording.

Because of the close proximity between the holographic layer and mask during recording, and between the hologram and substrate during reconstruction, the TIR holographic method provides a very high numerical aperture (˜1) in comparison with traditional photolithographic methods which enables a relatively high resolution features to be imaged using a given exposure wavelength, for example, 0.4 μm features may be printed with a wavelength of 364 nm. Further TIR holographic lithography possesses no trade-off between feature resolution and pattern size, so it can print, for example, a 0.4 μm-resolution pattern of dimensions 150 mm×150 mm. Lithographic exposure equipment based on this technique operating at a UV wavelength of 364 nm has been developed and commercialised. A draw-back of the TIR holographic technique arises because of the type of hologram and holographic recording materials that have been used: the holograms employed have generally been “volume” holograms in which the mask pattern is recorded either by a modulation of the refractive index of the holographic recording material, in the case of, for example, photopolymers, or by a modulation of its absorption, in the case of, for example, photographic emulsions. Such recording materials, however, are not ideally robust to extended periods of illumination by a high-intensity UV laser beam, and this can be a problem if the holograms have to withstand very high and virtually continuous levels of UV light, as would be the case on a lithographic equipment employed for high-volume production of flat panel displays. Other types of hologram and holographic recording material exist, namely “surface-relief” holograms and photoresist materials respectively that permit more robust holograms, but because of the recording mechanism of the TIR holographic method, they are not readily applicable to hologram masks. U.S. patent application Ser. No. 10/009,944 describes a method for recording surface-relief hologram masks in which particular polarisations are employed for the object and reference beams but the recording process is difficult to optimise.

It is an object of this invention to provide a method and apparatus for manufacturing surface-relief hologram masks for use in lithographic equipment based on total internal reflection holography in which pattern is recorded in the hologram as a variation the thickness of the recording material. It is a second object of this invention that said hologram masks are robust to long-term and intense illumination from a laser source, particularly at UV or DUV wavelength. It is a third object of the present invention that the hologram masks thus formed can be cleaned so that any contamination to the hologram mask by, for instance, handling procedures may be readily removed by a simple cleaning process thus prolonging the life of the hologram mask.

According to a first aspect of this invention, there is provided a method for manufacturing a surface-relief hologram mask for use on a lithographic system based on TIR holography which comprises the steps of:
i) providing a master hologram mask comprising a volume hologram of a pattern of features on a first substrate recorded using a TIR holographic recording system and a volume holographic recording material, and wherein the volume hologram includes a transmission image hologram and a reflection image hologram;
ii) arranging the master hologram mask on the first face of a coupling element having a second face through which an exposure beam may pass for reconstructing the pattern recorded in the volume hologram;
iii) providing an illumination system with an exposure beam for illuminating the master hologram mask through the second face of the coupling element and for reconstructing the pattern recorded in the volume hologram;
iv) providing a recording plate comprising a layer of a surface-relief holographic recording material on a first surface of a second substrate;
v) arranging the recording plate on the master hologram mask such that the recording layer is in proximity or contact with the volume hologram and such that light in an exposure beam from said illumination system that illuminates the volume hologram but is not diffracted by said hologram is transmitted into the recording layer;
vi) inhibiting the recording by an exposure beam from said illumination system of the reflection image hologram in the recording layer;
vii) illuminating the master hologram mask with an exposure beam from the illumination system and recording the transmission image hologram in the recording layer;
viii) processing the recording plate to form a surface-relief structure in the recording layer.

In the step of arranging the recording plate on the master hologram mask, it is preferable that a layer of fluid is introduced between the volume hologram and the recording layer so that the light in the exposure beam that is not diffracted by the volume hologram is transmitted into the recording layer instead of being totally internally reflected from the surface of the volume hologram.

The step of inhibiting the recording of the reflection image hologram of the volume hologram in the recording layer is preferably by inhibiting the total internal reflection of said undiffracted light in the exposure beam from a second surface of the second substrate following its passage through the recording layer. This might be achieved either by arranging an absorbing element on the second face of the second substrate, or alternatively by arranging a second coupling element such as a prism on the second surface of the second substrate, with a layer of fluid between the two, in order that the undiffracted light leaves the second substrate and so that it is subsequently transmitted through another face of the coupling element. The thickness of the second substrate may also be selected to be large enough in elation to the size of the pattern recorded in the volume hologram in order that the undiffracted light that is totally internally reflected from the second surface of the second substrate does not illuminate that part of the recording layer that records the transmission image hologram. It can further be advantageous that the coherence of the light in the exposure beam is reduced in order that spurious reflections of the exposure beam are made incoherent with the light recording the transmission image hologram in the recording layer.

In order that the recording layer and master hologram mask can be easily separated following the illumination of the master hologram mask with the exposure beam it is advantageous that at least one of the volume hologram and the recording layer is initially coated or otherwise treated on its surface in order to reduce the adhesion between the two. A coating or treatment may also be applied to at least of the surfaces in order to protect the hologram or recording layer from the ingress of fluid, from abrasion or for reducing the reflectivity of an exposure beam from the illumination system during the recording of the transmission image hologram in the recording layer.

Following the formation of the surface-relief structure in the second recording layer, it is further preferable that the surface-relief structure is transferred by a process or combination of processes into the underlying material of the second substrate. This material may either be that of the bulk substrate or it may be that of an intermediate layer provided on the surface of the bulk substrate.

The surface-relief structure may alternatively be transferred from the recording plate onto a third substrate using another process or combination of processes.

Following the formation of the surface-relief structure either in the recording material, in the underlying material of the second substrate or on the third substrate, the surface-relief structure may coated with a thin layer of a material or a treatment otherwise applied to the surface-relief structure, which conforms to the surface-relief profile, in order that, for example, the surface-relief structure can be more easily cleaned, reduces the deposition and adhesion of particles onto the structure by electrostatic forces, or to act as an anti-reflection coating in order to increase the diffraction efficiency of the hologram.

In order that the transmission image hologram is recorded uniformly into the recording layer over the surface of the layer, it is preferable that the illumination system includes a scanning system that scans the exposure beam over the surface of the master hologram mask. The beam preferably has a Gaussian intensity profile and the scanning is preferably performed in a raster pattern.

It is further advantageous that the thickness of the second recording layer and the exposure energy density produced by the illumination system are selected in order to optimise the depth of the surface-relief structure in order to maximise the diffraction efficiency of the resulting surface-relief hologram.

According to a second aspect of this invention, there is provided an apparatus for manufacturing a surface-relief hologram mask for use on a lithographic system based on TIR holography which includes:
i) a master hologram mask comprising a volume hologram of a pattern of features on a first substrate recorded using TIR holography and a volume holographic recording material, and wherein the volume hologram includes a transmission image hologram and reflection image hologram;
ii) a coupling element having the master hologram mask arranged on a first face thereof and having a second face through which an exposure beam may pass for reconstructing the pattern recorded in the volume hologram;
iii) an illumination system having an exposure beam for illuminating the master hologram mask through the second face of the coupling element and for reconstructing the pattern recorded in the volume hologram;
iv) a recording plate including a layer of a surface-relief holographic recording material on a first surface of a second substrate
v) a means for arranging the recording plate on the master hologram mask such that the recording layer is in proximity or contact with the volume hologram and such that light in an exposure beam from said illumination system that illuminates the volume hologram but is not diffracted by said hologram is transmitted into the recording layer;
vi) a means for inhibiting the recording by an exposure beam from said illumination system of the reflection image hologram in the recording layer;
vii) a means for processing the recording plate following the recording of the transmission image hologram in the recording layer to form a surface-relief structure in the recording layer.

The coupling element is preferably a refractive element such as a prism with at least 2 polished faces or alternatively may be a diffractive structure such as grating or a combination of gratings.

The means for arranging the recording plate on the master hologram mask such that the undiffracted light of the exposure beam is transmitted from the volume hologram into the recording layer is preferably a layer of fluid interposed between the volume hologram and the recording layer.

It is further preferable that a mechanical, pneumatic or other means be provided to apply pressure to the recording plate in relation to the master hologram mask in order to minimise at least one of the thickness of said fluid layer between the volume hologram and recording layer and the variation in thickness of the fluid layer across the layer.

It is preferable that the apparatus further include a mechanical means to stabilise or clamp the recording plate in relation to the master hologram mask in order that the transmission image hologram is accurately recorded in the recording layer.

The means for inhibiting the recording by an exposure beam from said illumination system of the reflection image hologram in the recording layer is preferably an absorbing plate arranged on a second surface of the second substrate with a layer of fluid between the two such that the undiffracted light in the exposure beam that is transmitted through the recording layer is absorbed by said absorbing plate. The absorbing element might alternatively be a layer of an absorbing material which has been spin coated to the second surface of the second plate. In the case that the surface-relief structure obtained in the recording layer is to be subsequently transferred to a third substrate, the means for inhibiting the recording of the reflection hologram in the recording layer may alternatively be employing the material of the second substrate which is selected to be absorbing.

Preferably, the apparatus of the invention may additionally include a layer or treatment applied to at least one of the volume hologram and recording layer before they are arranged in proximity or contact that facilitates their separation and/or cleaning following the recording of the transmission image hologram in the recording layer. Such a layer or layers might additionally or alternatively be used to render at least one of the volume hologram or recording layer more robust so that, for example, the method of the invention may be applied many times to the master hologram mask thereby enabling the transmission image hologram to be recorded a plurality of times in a plurality of recording layers on a plurality of recording plates. The layer or layers may also or alternatively be used to modify the optical properties of the volume hologram or recording layer during the exposure step, for example, the layer or layers may be used as anti-reflection coatings to suppress certain reflections. Such a layer or layers with such a function may also be disposed between the volume hologram and the first substrate or between the recording layer and the second substrate.

Advantageously, the apparatus of the present invention additionally includes means for transferring the surface-relief structure formed in the recording layer into the underlying material of the second substrate, which material might be either that of the bulk substrate or that of an intermediate layer provided on the surface of the bulk substrate, which together the second substrate. Means might alternatively be provided for transferring the surface-relief structure formed in the recording layer onto the surface of a third substrate.

Preferred embodiments of the invention will now be described in greater detail with reference to the following drawings, wherein:

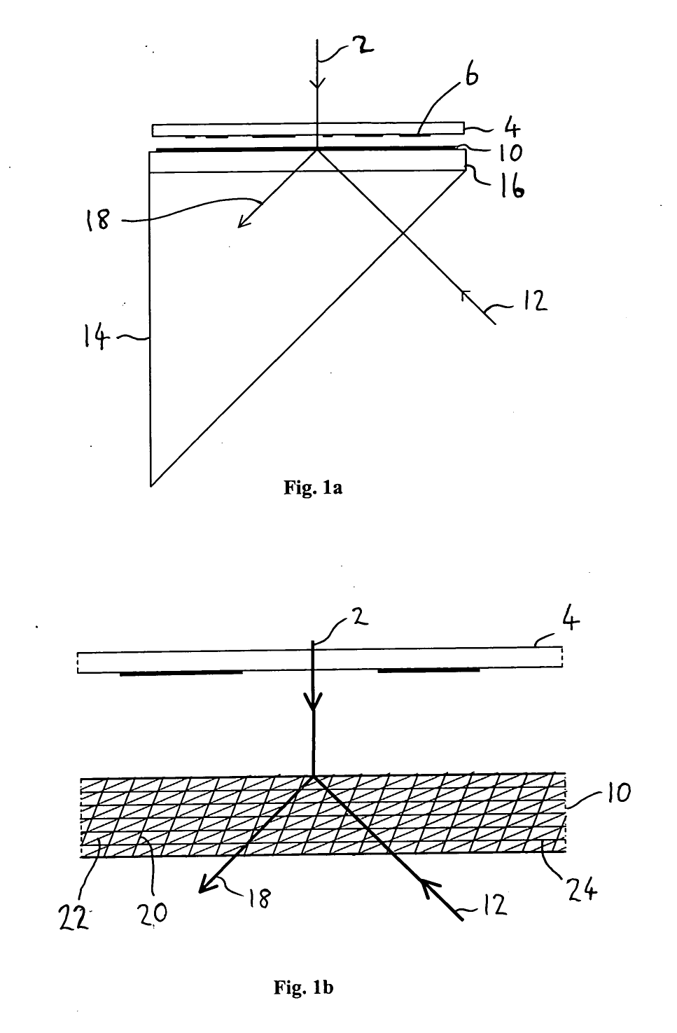

FIG. 1a illustrates the recording mechanism of TIR holography according to the prior art.

FIG. 1b shows in detail the optical interference patterns recorded in the holographic recording layer according to the prior art.

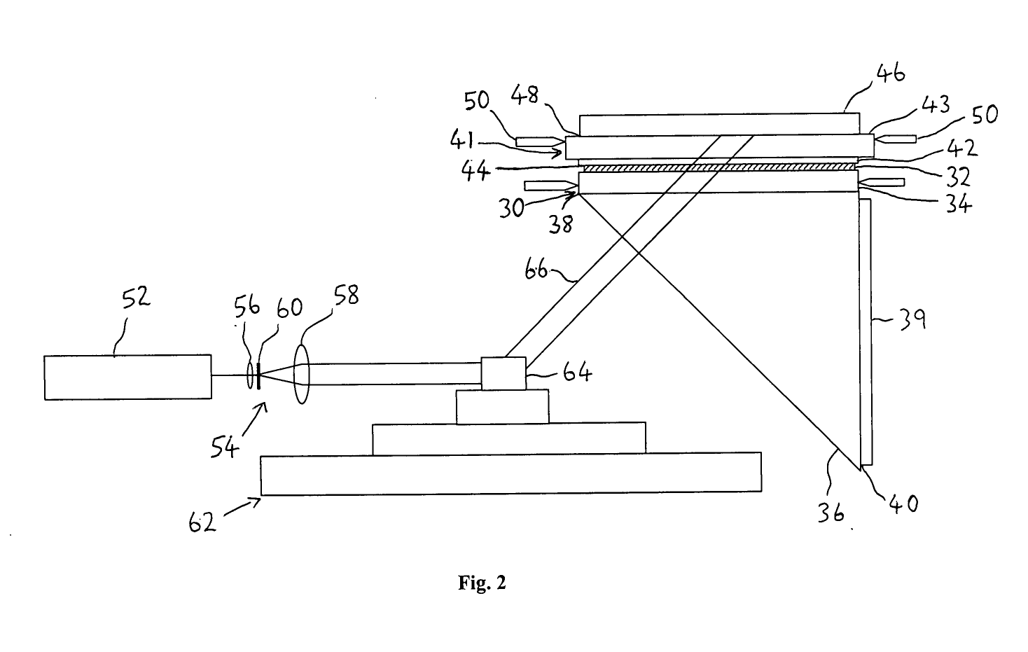

FIG. 2 shows a preferred embodiment for recording a surface-relief hologram mask from a master hologram mask.

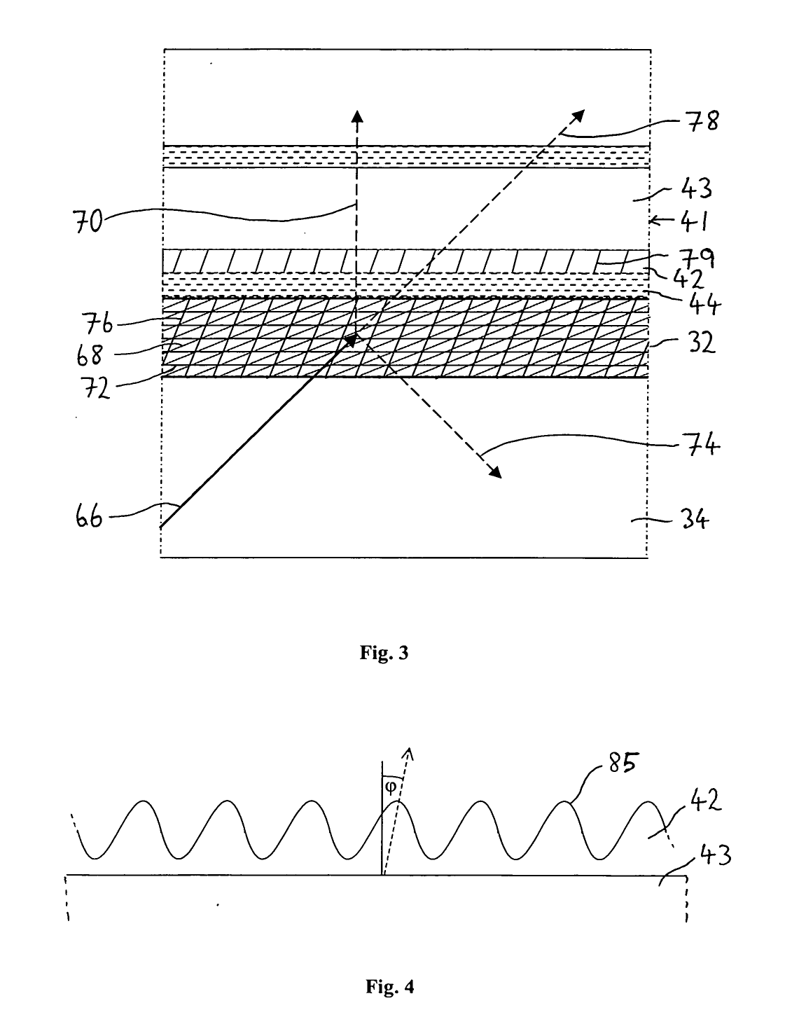

FIG. 3 shows the interaction of the exposure beam with the 3 components of a master hologram mask and the recording of the surface-relief hologram mask.

FIG. 4 illustrates the cross-sectional profile of the surface-relief hologram formed in the recording layer.

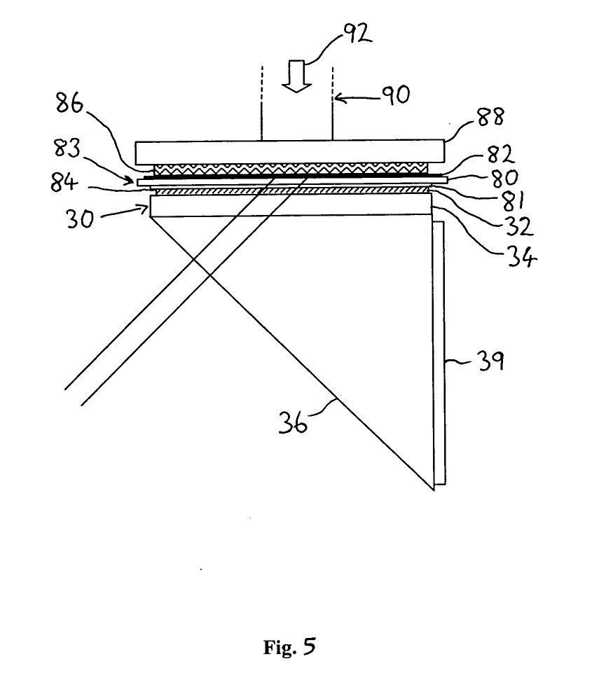

FIG. 5 shows an alternative embodiment of the invention including means for achieving a thinner and more uniform fluid layer between the master hologram mask and the recording layer.

In order to understand and appreciate the limitations of the prior art TIR holograms recorded using the prior art, it is necessary to consider in more detail the recording mechanism of TIR holography based on the prior art. With reference firstly to FIG. 1a, the object beam 2 illuminates the mask 4 containing the pattern 6 to be recorded in the hologram and the light transmitted and diffracted by the pattern features 6 illuminates the recording layer 10. The reference beam 12 on the other hand passes through the prism 14 and through the holographic plate 16 to the surface of the holographic recording layer 10 where it is totally internally reflected because of the high angle of incidence. This reflected beam 18 then travels back through the recording layer 10. Because of this there are effectively three beams that participate in the recording process: the object beam 2 transmitted by the mask, the reference beam incident 12 on the holographic recording layer 10, and the reflected reference beam 18. To understand the form of the resulting interference pattern in the holographic recording layer and also the properties of the TIR hologram, the interaction of the 3 beams may rather be considered as a superposition of the interactions between the 3 possible pairs of beams, that is, the object beam 2 and the reflected reference beam 18, the object beam 2 and the incident reference beam 12, and lastly the incident reference beam 12 and the reflected reference beam 18. Each of these beam combinations generates an interference pattern which is recorded by the photosensitive material of the recording layer 10 to produce its own hologram component. Referring now to FIG. 1b which shows a magnified view if the interfering beams in the within the thickness of the holographic recording layer, the interaction of the object beam 2 with the reflected reference beam 18 produces essentially (just considering the “0” order light transmitted by the mask) a set of high-angle interference fringes 20 in the recording layer 10, which form a transmission hologram of the mask pattern; the interaction of the object beam 2 with the incident reference beam 12 produces essentially a set of low-angle interference fringes 22 which forms a reflection image hologram of the mask pattern; and lastly the interaction between the incident and reflected reference beams 12, 18 produces a set of interference fringes 24 parallel to the surface of the recording layer 10 which forms a Lippmann mirror hologram, containing no information on the mask pattern. Whereas the internal structure of the total internal reflection hologram is shown in FIG. 1 to be highly regular and periodic, with the planes of refractive index for each of the transmission image hologram and reflection image hologram shown to be parallel at particular orientations, this as mentioned above is only for the simplified case of light passing through the mask without angular deflection. In the general case the light transmitted by the mask will be diffracted by the pattern features in the mask, the angular distribution of the diffracted light from a particular part of the mask being dependent on the composition of features at that location. Thus the form of the interference pattern generated in the holographic recording layer will generally be a very distorted version of that shown in FIG. 1. It should be further mentioned that the strengths of the 3 hologram components also depend on the polarisations of the incident object and reference beams.

The superposition of the 3 hologram components therefore produces a complex light distribution in the recording layer that requires a “volume” holographic recording material for it to be accurately recorded. A volume holographic recording material records an optical interference pattern either as a modulation in the refractive index of the recording material or as a modulation of its absorption. Surface-relief holographic recording materials, on the other hand, are not readily applicable to TIR holography because they are unable to record a complex variation of light intensity through the thickness of the recording layer and the overlapping interference patterns prevent a surface-relief structure of significant depth from being formed. U.S. patent application Ser. No. 10/009,944 discloses a TIR holographic recording method in which special polarisations are employed for the object and reference beams in order to suppress the reflection image hologram and Lippmann holograms relative to the transmission image hologram, so that a surface-relief structure may be formed. This holographic recording process is, however, difficult to optimise for obtaining the required performance from the hologram.

FIG. 2 shows a preferred embodiment of the present invention for forming a hologram mask for use on a lithographic system based on TIR holography. A master hologram mask 30 comprising a volume hologram 32 on the surface of a glass substrate 34 is mounted to the top surface of a glass prism 36 with a layer of transparent optical fluid 38 such as a suitable immersion fluid (transparent and having the same refractive index as the glass) manufactured by Cargille Laboratories Inc. at the interface between the two. The master hologram mask 30 was recorded using the standard methods of TIR holography as taught in the prior art using one of the Omnidex family of photopolymer holographic recording materials manufactured by the company Dupont de Nemours Inc. The laser source employed for recording was an argon ion laser with an emission wavelength of 363.8 nm, and thus the surface period of the transmission image hologram of the master hologram 32 is ˜0.35 micron (just considering the 0 order light diffracted by the pattern in the original chrome mask). The refractive index of the fluid 38 is selected such that it has substantially the same refractive index as the substrate 34 and prism 36 at ˜1.5. An absorbing plate 39 is mounted to the vertical face of the prism 36 with a layer of transparent fluid 40 at the interface between the two. A holographic recording plate 41 has been prepared by spin coating a ˜0.3 μm thickness layer of a high-resolution positive i-line sensitive photoresist 42, available from such commercial suppliers for the microelectronics industry as Shipley Company Inc., onto a transparent substrate 43. Some drops of a suitable immersion fluid from Cargille laboratories Inc (inert, transparent fluid and having a refractive index close to that of the hologram photopolymer) are added to the surface of the hologram 32 and the recording plate 41 is carefully lowered onto the master hologram mask 30 with the photoresist layer 42 facing towards the volume hologram 32, being careful not to introduce bubbles into the fluid layer 44 during this operation. Onto the other side of the recording plate 41 is placed a plate of neutral-density absorbing glass 46, also with a layer of transparent fluid 48 introduced at the interface between the two. Both the master hologram mask 30 and the recording plate 38 are held rigidly in position by applying four clamping screws 50 to their edges, thus ensuring that there is no relative movement between the two during the exposure step. The absorbing plate 46 should also be fixed, though its positional stability is not so critical.

To the left of this assembly is the exposure system incorporating firstly an argon ion laser 52 operating at a wavelength of 363.8 nm, the same wavelength at which the hologram mask 30 was recorded. The output beam from the laser 52, which is in TEM00 mode with a Gaussian intensity profile, passes through a beam expander system 54 consisting of 2 lenses 56, 58 for increasing the 1/e² diameter of the beam to ˜10 mm and also a spatial filter 60 for eliminating noise in the beam. The resulting beam is then incident on a 2-axis scanning system 62 on which are mounted a pair of mirrors the first of which, 64, reflects the beam towards the second mirror (not explicitly shown in the diagram because it is obscured by the first mirror 64) which subsequently reflects the beam so that it is arrives at the hypotenuse face of the prism 36 at normal incidence. The orthogonally configured motorised stages of the 2-axis scanning system 62 are linked to a control system (not shown) that generates a raster scan of the UV beam 66 across the hypotenuse face of the prism 36 and thence over the master hologram mask 30. The stepping distance of the beam 66 between successive scan passes in the raster pattern is selected to be ˜3 mm in order that the time-integrated energy density of the exposure is made uniform across the master hologram mask 30.

FIG. 3 shows in more detail the interaction of the exposure beam 66 of FIG. 2 with the 3 components of the master hologram 32. The transmission image hologram, represented by a set of high-angle planes of modulated refractive index 68, partially diffracts light in the incident beam 66 in a direction orthogonal to the plane of the hologram 32 (neglecting any angular deflection of the object beam by the mask features during hologram recording). The diffracted light 70 leaves the hologram 32 and illuminates the recording plate 41. The Lippmann hologram, represented by the planes of modulated refractive index 72 parallel to the surface of the hologram 32, partially reflects the exposure beam 66, the reflected light 74 passing back through the hologram substrate 34 into the prism 36, after which it is absorbed by the absorbing plate 39. The incident exposure beam 66 does not, however, directly interact with the reflection image hologram of the hologram 32, represented by of the low-angle planes of modulated refractive index 76, because the beam's angle of incidence is too far from the Bragg angle of this hologram component. Unlike for a normal interaction of an exposure beam with a TIR hologram, light in the exposure beam 66 that is not diffracted by the hologram 32 is not totally internally reflected from the surface of the hologram 32 because the fluid 44 above the hologram 30 allows the beam to leave the hologram 32 and enter the photoresist layer 42 on the holographic recording plate 41. This transmitted, undiffracted light 78 is partially reflected from the interface between the hologram 32 and the fluid layer 44, from that between the fluid layer 44 and the photoresist layer 42, and from that between the photoresist layer and its substrate 43 on account of the differences in the refractive indices of the respective materials. However, the reflected light is weak in comparison with the light-field 70 diffracted by the transmission image hologram. Its magnitude may be minimised by selecting appropriate photoresist, fluid and substrate materials in order to minimise the differences between their refractive indices, and also by the use of anti-reflection coatings included, for example, between the photoresist layer 42 and its substrate 43.

The light passing into the layer of photoresist 42 is essentially therefore the light-field 70 diffracted by the transmission hologram as well as the undiffracted light of the exposure beam 78. Since these two light-fields 70, 78 are mutually coherent, they interfere and the resulting fringe pattern 79 is recorded by the photoresist layer 44. This fringe pattern 79 corresponds to that of the transmission image hologram of the master hologram 32 with, thus allowing a surface-relief hologram to be formed. From the figure it can be seen that the individual fringes in the fringe pattern 79 are not orientated orthogonally to the plane of the substrate 43 but are tilted at a small angle, the magnitude of which depends on the refractive index of the recording layer 42. It should be further noted the tilt of the fringes at a particular location in the resulting hologram with respect to its substrate 43 are in the opposite direction to that of the planes of refractive index of the transmission image hologram in the master hologram 32 with respect to its substrate 34, in other words, the structure of the fringe pattern 79 recorded in the recording layer 42 with respect to its substrate 43 is rather the mirror image of that of the transmission image hologram 76 in the master hologram 32 with respect to its substrate 34.

The time-integrated energy density, E, of the laser exposure of the master hologram 32 is related to the power, P, of the laser beam, to the stepping distance, s, and scanning speed, v, of the raster pattern by
E=P/vs

These parameters are optimised in order that the depth of the surface-relief profile obtained in the recording layer 42 following development yields high diffraction efficiency in the resulting hologram. The depth required depends on the refractive index of the recording material after development: the two are inversely related, that is, the higher the refractive index of the material, the shallower the profile needed. The optimum depth may be determined empirically by experiment or alternatively using standard theoretical treatments known to those skilled in the art such as rigorous coupled wave theory developed by M. G. Moharam and T. K. Gaylord (“Diffraction analysis of dielectric surface-relief gratings”, J. Opt. Soc. Am., 72(10) pp. 1385-1392; 1982). Typically, the exposure parameters are selected to achieve a depth of profile in the resist of 0.15 μm.

The depth of the resulting surface-relief profile, in fact, varies across the recording layer 42 depending on the distribution of the features in the mask pattern from which the master hologram mask 30 was recorded, and thus the exposure energy density should also be selected to assure a linear recording of the light-field diffracted by the master hologram 32. The diffraction efficiency of the original hologram and the photoresist process including its thickness should also be optimised for ensuring a good linearity of recording using such procedures and analytical techniques as would be familiar to one experienced in the art. Negative photoresists may alternatively be used as the recording material

In order for method to be applied to patterns of high-resolution features (such as 0.5 μm), it is important that both the thickness of the fluid layer 44 between the master hologram 32 and the photoresist layer 42 and its variation across the layer 42 are minimised. This may be achieved in a number of ways: firstly by minimising the quantity of fluid employed, secondly by ensuring that the surfaces of the hologram substrate 34 and the recording plate substrate 43 are very flat, and thirdly by minimising the size and number of defects in, on or between the hologram 32 and recording layer 42. For the latter, it is advantageous that both the master hologram mask 30 and the surface-relief hologram mask are recorded in a high-quality clean-room environment having, for example, Class 10 conditions and that all other necessary measures and procedures are implemented for minimising particles.

After the exposure operation, the recording plate 41 is removed from the system and the fluid cleaned from its surfaces by, preferably, a spin cleaning process. The photoresist layer 42 is then be developed using processing conditions optimised for achieving the required linearity of recording and the required depth of profile for high diffraction efficiency, as previously discussed. Because the fringes 79 in the interference pattern recorded in recording layer 42 are tilted from the normal with respect to the substrate 43, as described above, the cross-sectional profiles of the resulting surface-relief hologram are also tilted with respect to the substrate 43. This is illustrated in FIG. 4 in which the peaks of the surface-relief profile 85 formed in the recording layer 42 are shown to be asymmetric with a tilt angle of φ with respect to the normal to the surface of the substrate 43.

FIG. 5 shows another preferred embodiment of the invention which particularly addresses the requirements for achieving a thin and uniform thickness of fluid layer between the master hologram and recording plate, which is especially important for high-resolution lithography. In this case the recording plate substrate 80 is a thin glass plate, only 2 mm thick, with accurately polished surfaces and the absorber on its upper surface is rather a film of photoresist 82 incorporating a high concentration of an absorbing dye that has been spin-coated onto the substrate and afterwards heated in an oven at 150° C. to harden and stabilise it. Other materials such as paints, resins, etc might alternatively be employed as similarly or otherwise applied as the absorbing film. After mounting the recording plate 83 onto the hologram mask 30 as before, with a layer of fluid 84 at the interface between the layer of photoresist 81 and the hologram 32, a thick rubber sheet 86 is laid onto its upper surface. Following this a metal plate 88, part of a clamping mechanism 90, is lowered onto the rubber sheet 86 and a force 92 applied from above by standard mechanical means in order to apply a pressure to the metal plate 88 and thence to the recording plate 83 below. Such a pressure might alternatively be applied by a pneumatic or other means. On account of the mechanical structure, including the rubber sheet 86 and the thickness of the recording plate substrate 80, the pressure, or loading, on the recording plate 83 causes the substrate 80 to deform so that the recording layer 81 on its lower surface conforms to the contours of the master hologram 32, thereby achieving a thinner and more uniform thickness of the fluid layer 84 between the master hologram 32 and recording layer 81. After clamping the recording plate 83 in place the exposure operation can then proceed as before by scanning the exposure beam 66 in a raster pattern through the hypotenuse of the prism 36 and across the hologram mask 30.

In order that the recording layer 81 and the master hologram 32 can be readily separated after the exposure, it is advantageous that at least one of the surfaces of the master hologram 32 and recording layer 81 are pre-coated or otherwise treated with a material to reduce adhesion between the two.

In order to strengthen and better stabilise the surface-relief structure of the photoresist in the resulting copy hologram, it may subjected to a high-temperature heat treatment either on a hot plate or in an oven. To provide a more robust hologram for use on a high-throughput lithographic equipment for, for example, the manufacture of flat panel displays, the resist profile may be transferred into the underlying substrate by further processing, such as by reactive ion etching. In this case the depth of the surface-relief profile produced in the photoresist should be such that the selectivity of the resist process (i.e. the relative etching speeds of the photoresist and substrate materials) yields the required range of depths of profile in the substrate. The gas mixture and other process conditions for the RIE etching should be selected so that the resulting surface-profile is smooth: if the etching is too aggressive a rough, granulated surface is obtained which generates undesirable scatter and noise in the image reconstructed from the copy hologram. The necessary process conditions can be readily determined by standard techniques by those skilled in the art. Furthermore, by adjusting the angle of incidence of the etching ions, the angle of tilt of the resulting surface-relief profile may be modified in order to enhance the diffractive behaviour and performance of the resulting hologram mask. More complex, multi-step processes may also be employed for transferring the profile into the underlying substrate, including using intermediate deposition, planarisation or etch-back processes. For obtaining high-quality, smooth profiles of sufficient depth in the substrate using such etching processes, it is advantageous that the substrate material is fused silica rather than a glass, or alternatively that the substrate comprises a glass plate with a layer of, for example, silicon dioxide deposited on it surface with the photoresist spin-coated onto the silicon dioxide and that the surface-relief profile then be transferred into the layer of silicon dioxide by the etching process. Further, other techniques and combinations of technologies such as, for example, shim fabrication and casting methods, using such materials as sol-gels, may be employed to transfer the surface-relief structure formed in the photoresist onto another substrate. With such a transfer the direction of tilt of the surface-relief profile relative to its substrate may also be reversed, again allowing enhancement of the image-forming properties of the resulting hologram mask.

1. A method for manufacturing a surface-relief hologram mask for use on a lithographic system based on TIR holography which comprises the steps of:
i) providing a master hologram mask comprising a volume hologram of a pattern of features recorded on a first substrate using a TIR holographic recording system and a volume holographic recording material, and wherein the volume hologram includes a transmission image hologram and a reflection image hologram;
ii) arranging the master hologram mask on the first face of a coupling element having a second face through which an exposure beam may pass for reconstructing the pattern recorded in the volume hologram;
iii) providing an illumination system with an exposure beam for illuminating the master hologram mask through the second face of the coupling element and for reconstructing the pattern recorded in the volume hologram;
iv) providing a recording plate comprising a layer of a surface-relief holographic recording material on a first surface of a second substrate;
v) arranging the recording plate on the master hologram mask such that the recording layer is in proximity or contact with the volume hologram and such that light in an exposure beam from said illumination system that illuminates the volume hologram but is not diffracted by the volume hologram is transmitted into the recording layer;
vi) inhibiting the recording by an exposure beam from said illumination system of the reflection image hologram in the recording layer;
vii) illuminating the master hologram mask with an exposure beam from the illumination system and recording the transmission image hologram in the recording layer;
viii) processing the recording plate to form a surface-relief structure in the recording layer.

2. A method according to claim 1, wherein arranging the recording plate on the master hologram mask includes interposing a layer of fluid between the volume hologram and the recording layer.

3. A method according to claim 1, wherein inhibiting the recording of the reflection image hologram in the recording layer is by inhibiting the total internal reflection of said undiffracted light in the exposure beam from a second surface of the second substrate following its passage through the recording layer.

4. A method according to claim 1, wherein providing an illumination system for reconstructing an image of the pattern recorded in the hologram master mask includes providing a scanning system for scanning an exposure beam preferably in a raster pattern over the master hologram mask.

5. A method according to claim 1 that further comprises applying a layer or treatment to at least one of the volume hologram and recording layer before they are arranged in contact or proximity so as to modify any of their physical, chemical and optical properties in order to facilitate the method or enhance the results of the method.

6. A method according to claim 1 that further comprises transferring the surface-relief structure formed in the recording layer into the underlying material at the first surface of the second substrate by a process.

7. A method according to claim 1 that further comprises transferring the structure of the surface-relief hologram formed in the recording layer onto a third substrate by a process or a combination of processes.

8. A method according to claim 6 wherein at least one of the magnitude of tilt and direction of tilt of the profiles of the surface-relief structure transferred into the underlying material at the first surface of the second substrate is changed with respect to those of the profiles of the surface-relief structure formed in the recording layer.

9. A method according to claim 1 that further comprises repeating the steps iv) to viii) a plurality of times using a plurality of recording plates in order to record the transmission image hologram in a plurality of recording layers to form a plurality of surface-relief structures.

10. An apparatus for manufacturing a surface-relief hologram mask for use on a lithographic system based on TIR holography which includes:
i) a master hologram mask comprising a volume hologram of a pattern of features recorded on a first substrate using TIR holography and a volume holographic recording material, and wherein the volume hologram includes a transmission image hologram and a reflection image hologram;
ii) a coupling element having the master hologram mask arranged on a first face thereof and having a second face through which an exposure beam may pass for reconstructing the pattern recorded in the volume hologram;
iii) an illumination system having an exposure beam for illuminating the hologram mask through the second face of the coupling element and reconstructing the pattern recorded in the volume hologram;
iv) a recording plate comprising a layer of a surface-relief holographic recording material on a first surface of a second substrate
v) a means for arranging the recording plate on the master hologram mask such that the recording layer is in proximity or contact with the volume hologram and such that light in an exposure beam from said illumination system that illuminates the volume hologram but is not diffracted by said hologram is transmitted into the recording layer;
vi) a means for inhibiting or suppressing the recording by an exposure beam from said illumination system of the reflection image hologram in the recording layer;
vii) a means for processing the recording plate following the recording of the transmission image hologram in the recording layer to form a surface-relief structure in the recording layer.

11. An apparatus according to claim 10 that further includes a layer of fluid between the volume hologram and the recording layer.

12. An apparatus according to claim 11 that further includes a means for applying pressure to the recording plate relative to the master hologram mask in order to reduce at least one of the thickness of the fluid layer and the variation in thickness of the fluid layer across the layer.

13. An apparatus according to claim 10, wherein the means for inhibiting or suppressing the recording of the reflection image hologram in the recording layer is an absorbing element or material arranged on a second surface of the second substrate for absorbing the undiffracted light in the exposure beam following its passage through the recording layer.

14. An apparatus according to claim 10, wherein the illumination system for reconstructing an image of the pattern recorded in the master hologram mask includes a scanning system for scanning the exposure beam over the master hologram mask in preferably a raster pattern.

15. An apparatus according to claim 10, wherein the coupling element is a prism or a diffractive element.

16. An apparatus according to claim 10 that additionally includes a means for stabilising the position of the recording plate in relation to the master hologram mask during the recording of the transmission image hologram in the recording layer.

17. An apparatus according to claim 10 that additionally includes a means for transferring the surface-relief structure formed in the recording layer into the underlying material at the first surface of the second substrate.

18. An apparatus according to claim 10 wherein the second substrate comprises a base substrate of a first material having at least one layer of a second or another material on its first surface, and wherein the recording layer is applied to the layer of the second or other material.

19. An apparatus according to claim 17 wherein the means for transferring the surface-relief structure formed in the recording layer into the underlying material at the first surface of the second substrate includes means for changing at least one of the magnitude of tilt and direction of tilt of the profiles of the surface-relief structure formed in the underlying material with respect to those of the profiles of the surface-relief structure formed in the recording layer.

20. An apparatus according to claim 10 wherein the means for inhibiting or suppressing the recording by an exposure beam from said illumination system of the reflection image hologram in the recording layer is the material of the second substrate which is selected so that it absorbs the undiffracted light in the exposure beam following its passage through the recording layer.
